(19) United States
(12) Patent Application Publication
(10) Pub. No.: US 2026/0243096 A1
(43) Pub. Date: Aug. 20, 2026

(54) TEMPORARY CONTAINMENT BARRIERS AND RELATED METHODS

(71) Applicant: NUSENS IP, INC., NEWARK, DE (US)

(72) Inventors: ALEX MILIC, ETOBICOKE (CA); TARAS KALNOOCHENKO, ETOBICOKE (CA); MIREK PLANETA, NORTH YORK (CA); ALEX MANN, NORTH YORK (CA)

(21) Appl. No.: 19/641,841

(22) Filed: Apr. 8, 2026

Related U.S. Application Data
(63) Continuation of application No. PCT/IB2024/059981, filed on Oct. 11, 2024.
(60) Provisional application No. 63/590,065, filed on Oct. 13, 2023.

(51) Int. Cl. E04G 21/30

(52) U.S. Cl. CPC E04G 21/30

(57) ABSTRACT

A temporary containment barrier for use during construction or renovations of buildings includes a plastic film that is configured to shrink if exposed to heat. The film may have a melting point between 60 and 140 degrees Celsius. The film may be configured to shrink between 20 and 60% in at least one direction if exposed to heat. At least a portion of the film may be monoaxially oriented. At least a portion of the film may be biaxially oriented. The film may have a thickness of between 30 and 300 microns. The film may include at least one fire retardant modifier. In the case of a fire, the film can quickly dissipate and recede before fire suppression sprinklers will activate, and therefore will not impede operation of the sprinklers.

### CROSS-REFERENCE TO RELATED APPLICATIONS

This is a continuation of International Application No. PCT/IB2024/059981 filed on Oct. 11, 2024, which claims priority to U.S. Provisional Application No. 63/590,065 filed on Oct. 13, 2023, and the entire contents of each are hereby incorporated herein by reference.

### FIELD

The present disclosure relates generally to temporary protective barriers, which can be installed beneath ceilings to contain debris from construction work being performed on the ceiling or roof of a building.

### INTRODUCTION

The following paragraphs are not an admission that anything discussed in them is prior art or part of the knowledge of the person of ordinary skill in the art.

Plastic film can be used during construction or renovations of buildings, positioned inside underneath the ceiling, and optionally underneath the fire suppression sprinkler system. The barrier film is intended to catch dirt, dust and debris generated from construction work being performed on the ceiling or roof of the building, which may hinder equipment, inventory, processes, employees, customers, or the public in general. The film can be installed in a horizontal setting to separate the roof deck/ceiling from the area below. The film can also be installed in a vertical setting to act as “hoarding” to separate two adjacent spaces.

For example, grocery stores, food manufacturing/packaging facilities, health facilities and highly sensitive IT locations can be beneficiaries of such installation. Ceiling containment barriers can enable large businesses to remain open and conduct daily business activities safely, while ceiling and/or roofing projects are being undertaken.

The lifetime of the systems is typically a few months, until construction work is complete, after which the film and the debris captured within the film can be removed from the building and disposed of.

Ceiling containment barriers can interfere with the function of a building's sprinkler systems. Some existing systems rely on water-reactive seams, or melting seams, that connect sections of barrier to fail, therefore releasing the barrier and allowing the fire suppression sprinkler system access to the fire below. By relying on the seams to give way after contacting water, or heat in the specific area of the seams, there can be a significant delay during which the sprinkler system is activated. These systems also tend to be expensive, and can require site-specific pre-manufacturing/pre-fabrication based on location of fire sprinklers or depend on building layout, which can result in long lead times, more difficult installation, and a delayed response.

The following is intended to introduce the reader to the detailed description that follows and not to define or limit the claimed subject matter.

The present disclosure relates to a temporary containment barrier, including a plastic film, and the film is configured to shrink if exposed to heat.

The film can have a melting point between 60 and 140 degrees Celsius. The film can have a melting point between 70 and 120 degrees Celsius. The film can have a melting point between 80 and 110 degrees Celsius.

The film can be configured to shrink between 20 and 60% in at least one direction if exposed to heat. The film can be configured to shrink between 30 and 50% in at least one direction if exposed to heat. The film can be configured to shrink about 40% in at least one direction if exposed to heat.

The film can be configured to shrink if exposed to a temperature between 50 and 140 degrees Celsius. The film can be configured to shrink if exposed to a temperature between 60 and 120 degrees Celsius. The film can be configured to shrink if exposed to a temperature between 80 and 110 degrees Celsius.

The film can include at least one polymer selected from the group consisting of low-density polyethylene (LDPE), linear low-density polyethylene (LLDPE), high-density polyethylene (HDPE), ethylene-vinyl acetate (EVA), polypropylene (P), polyamide, polystyrene (PS), polyester, polyvinyl chloride (PVC), ethylene-propylene-diene terpolymer (EPT), copolymers thereof, and combinations thereof.

At least a portion of the film can be monoaxially oriented. The film can have a minimum 3:1 ratio of its orientation in a machine direction compared to a transverse direction. At least a portion of the film can be biaxially oriented.

The film can have a thickness of between 30 and 300 microns. The film can have a thickness of between 50 and 200 microns. The film can have a thickness of between 75 and 150 microns.

The film can have a Class A rating when evaluated by ASTM E84 for flame spread. The film can include at least one fire retardant modifier.

The film can be at least partially biodegradable. The film can include at least one pro-biodegradation additive.

The film can include at least one ultraviolet light stabilizer. The film can include at least one antistatic compound. The film can include at least one thermochromic material. The film can include at least one antiblock agent. The film can include at least one antifog additive. The film can include at least one fiber arranged as reinforcement.

A method of manufacturing the temporary containment barrier can include extruding the film from a die.

Other aspects and features of the teachings disclosed herein will become apparent, to those ordinarily skilled in the art, upon review of the following description of the specific examples of the present disclosure.

### BRIEF DESCRIPTION OF THE DRAWINGS

The drawings included herewith are for illustrating various examples of apparatuses and methods of the present disclosure and are not intended to limit the scope of what is taught in any way.

FIG. 1 is a schematic illustration of an apparatus for a blown film process.

FIG. 2 is a schematic illustration of an apparatus for a cast film process.

FIGS. 3A and 3B are schematic illustrations of a biaxially oriented film and a monoaxially oriented film, respectively, each reacting to an elevated temperature.

FIG. 4A is a schematic illustration of a film with reinforcement and FIG. 4B is a sectional view thereof.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

The present disclosure relates to the implementation of a plastic film, which has a low melting temperature, for use as a temporary containment barrier. The film can be configured so that, in the case of a fire, the film when in a horizontal setting will quickly dissipate and recede before fire suppression sprinklers will activate, and therefore it will not impede the operation of the sprinklers. In some examples, the barrier containment film can be made to be monoaxially oriented such that when exposed to an elevated temperature, e.g., exceeding 90 degrees Celsius, the film shrinks significantly, i.e. between 20 and 60%. The shrinking effect combined with the film material softening due to the elevated temperature results in faster film shrinking, collapse, going away from the source of fire, while simultaneously reducing the overall surface area of the plastic material which may be exposed to fire. This means that if there is a fire in the interior of a building that results in the interior temperature rising to a point where the fire suppression sprinklers would be activated resulting in the extinguishment of the fire, the film would have already shrunk, dissipated and receded away from the source of fire, opening up a hole in itself, exposing the source of fire to the sprinklers above at a lower temperature and in shorter time than required for the activation of the fire suppression sprinkler system, therefore getting out of the way of the sprinkler system and not impeding it.

In some examples, the barrier containment film can be made with a polymer selected from a group of materials with a lower melting point and/or higher MFI (melt flow index). Such films can provide a benefit of faster shrinkage, dissipation and receding in event of fire, thereby maximizing safety. For use as a temporary containment barrier, it is critical for the plastic film to be able to shrink, dissipate and recede to expose the sprinklers very quickly in the event of a fire. This exposes the sprinkler to the space underneath prior to the activation of the sprinklers. Thus, the barrier film can be made of low melting point materials. However, it cannot melt at such a low temperature that it could melt in hot climates or weaken to be less capable of bearing a load of larger debris. The film must function to contain debris that falls to fulfill its purpose.

In some examples, the film can have a melting point between 60 and 140 degrees Celsius. In some examples, the film can have a melting point between 70 and 120 degrees Celsius. In some examples, the film can have a melting point between 80 and 110 degrees Celsius. In some examples, the film can be configured to shrink between 20 and 60% in at least one direction if exposed to heat. In some examples, the film can be configured to shrink between 30 and 50% in at least one direction if exposed to heat. In some examples, the film can be configured to shrink about 40% in at least one direction if exposed to heat. In some examples, the film can be configured to shrink if exposed to a temperature between 50 and 140 degrees Celsius. In some examples, the film can be configured to shrink if exposed to a temperature between 60 and 120 degrees Celsius. In some examples, the film can be configured to shrink if exposed to a temperature between 80 and 110 degrees Celsius.

Various plastic materials can be used to form the film. In some examples, the film can be formed of at least one polymer selected from the group consisting of low-density polyethylene (LDPE), linear low-density polyethylene (LLDPE), high-density polyethylene (HDPE), ethylene-vinyl acetate (EVA), polypropylene (PP), polyamide, polystyrene (PS), polyester, polyvinyl chloride (PVC), ethylene-propylene-diene terpolymer (EPT), copolymers thereof, others known to persons skilled in the art, and combinations thereof.

In some examples, at least a portion of the film can be monoaxially oriented. With this microstructure, the film can shrink, dissipate and recede rapidly if it is exposed to a temperature above its melting point. In some examples, the film can have a minimum 3:1 ratio of its orientation in a machine direction compared to a transverse direction. The molecules can be oriented in one or two directions. During manufacture, the microstructure of the film can be “frozen” at low temperatures, and shrink, dissipate and recede rapidly when melted or otherwise heat-activated. In some examples, at least a portion of the film can be biaxially oriented. In some examples, the film can be extrusion oriented in one or two directions, post extrusion oriented biaxially as a polyolefin, LDPE, LLDPE, EVA, HDPE, PP or nylon, PS, polyester, PVC, EPT, depending what temperature is required for melting.

When plastic film is extruded from flat or tubular dies, the long molecule of the polymer gets extended and oriented in one direction. The amount of orientation can depend on the type of plastic, the molecular weight of the polymer, the means for extrusion, the temperature of the plastic when it leaves the die, and the speed of takeoff, and the orifice geometry for melt flow.

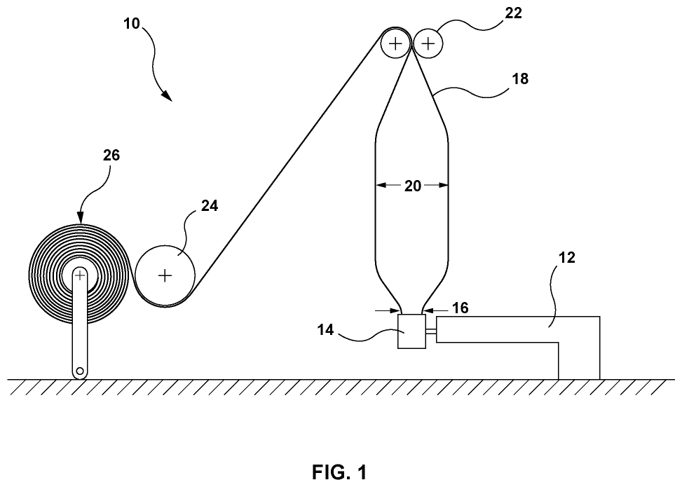

FIG. 1 illustrates an apparatus 10 for a blown film process. In the example illustrated, the apparatus 10 includes an extruder 12 and a tubular die 14 having a die diameter 16. A bubble/tube 18 of the film is blown from the die 14 and has a bubble diameter 20. The film is collected by take-off rollers 22 and a driven drum winder 24 delivers the film to be wound at 26.

The film manufactured using the apparatus 10 is typically only biaxially oriented. A blow-up ratio can be defined as the ratio of the bubble diameter 20 to the die diameter 16. Generally, the larger the blow-up ratio, the more balanced the orientation is achieved in the microstructure of the film.

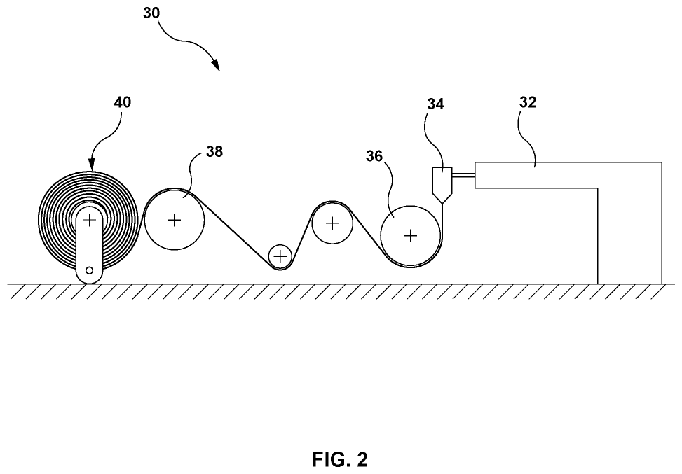

FIG. 2 illustrates an apparatus 30 for a cast film process. In the example illustrated, the apparatus 30 includes an extruder 32 and a flat die 34. Film that is extruded from the flat die 34 is collected by chill rollers 36 and a driven drum winder 38 delivers the film to be wound at 40. The biaxially oriented film can be produced by blown film or tender process where film is extruded as a cast and oriented in a transverse direction to achieve the balanced property. This can help with clarity and strength of the film but can make it more susceptible to tearing.

There are other methods for manufacturing suitable plastic films, e.g., calandering and film casting from a solvent. The two methods described above in relation to FIGS. 1 and 2 are exemplary. To achieve shrinkability, the film can be either monoaxially or biaxially oriented. The biaxial orientation can be either isotropic or anisotropic (same blob ratio or not). The orientation of the film can be typically achieved through imposing a certain amount of stretch into the film while in a molten or heated condition and cooling it off in such condition. In some cases, the desired film orientation can also be achieved as a cold stretch method.

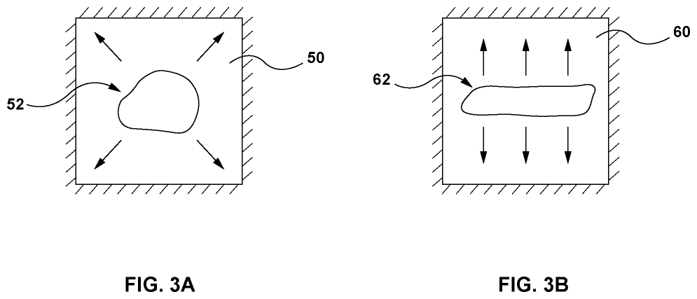

FIG. 3A shows a biaxially oriented film 50 and FIG. 3B shows a monoaxially oriented film 60, each after being exposed to an elevated temperature. As illustrated, the monoaxially oriented film 60 tends to break laterally compared to the biaxially oriented film 50, which instead exhibits a tendency to form holes 52. An advantage therefore of the monoaxially oriented film 60 is its reaction when exposed to high temperatures and fire, which is to shrink, dissipate and recede rapidly, indicated at reference numeral 62.

For use as a temporary containment barrier, the monoaxially oriented film or biaxially oriented film can be provided with a thickness of 30 to 300 microns, for example, and produced in accordance with the methods described above. In some examples, the film can have a thickness of between 50 and 200 microns. In some examples, the film can have a thickness of between 75 and 150 microns. In some examples, the films can be further stretched to enhance the orientation in that direction for quick retraction of the film when exposed to fire. In some examples, the films produced in accordance with the methods described above can be further stretched in one direction (monoaxially stretching) or two directions (biaxially stretching).

The film for a temporary containment barrier can have a low melting temperature so that it does not impede the operation of the fire sprinklers, yet simultaneously the film can also be fire retardant to resist flame-spread. For instance, the film can have a Class A rating when evaluated by the ASTM E84 testing for flame spread. In some examples, the film can be further capable of passing the NFPA 701 tests for flame propagation of textiles and films.

To improve its ability to resist flame spread, the film can include fire retardant additives selected from but not limited to halogenated flame retardants, such as brominated flame retardants or chlorinated flame retardants, non-halogenated flame retardants such as phosphorus-based flame retardants, metal oxide type like aluminum hydroxide, aluminum trihydrate or magnesium trioxide, magnesium hydroxide, others known to persons skilled in the art, and combinations thereof.

In some examples, the film can include at least one fire retardant modifier selected from the group consisting of decabromodiphenylethane, high-purity antimony trioxide (supplemented with flame retardant synergists and other additives and polyolefin as the carrier), 1-h-isoindole-1,3(2H)-dione, 2,2′-(1,2-ethanediyl)bis[4,5,6,7-tetrabromo-,phosphoric acid tributyl ester, antimony oxide (Sb₂O₃), benzene, 1,1′-(1-methylethylidene)bis[3,5-dibromo-4,2-phenylene)oxy]]bis-, ethanol, 2,2′-[(1-methylethylidene)bis[(2,6-dibromo-4,1-phenylene)oxy]]bis-, C12-30 α-bromo-chloro, alkenes, c12-24, chloro, phosphoric acid, tris(methylphenyl) ester, others known to persons skilled in the art, and combinations thereof.

In some examples, the film can be at least partially biodegradable. In some examples, the film can include at least one pro-biodegradation additive able to attract bacteria to the surface of the film. The bacteria colonize on the film surface and through its life cycle damages the underlying plastic film rendering it edible for such bacteria and which is then subsequently consumed by the bacteria. The process can be purely natural and chemotactic (facilitated by live organisms only) preventing formation of microplastic litter during degradation. The pro-biodegradation additive can contain naturally edible to bacteria substances, for example, starches, saccharides, polysaccharides, biodegradable polyesters, polylactic acid, polyhydroxyalkanoates, polycaprolactone, cellulose, others known to persons skilled in the art, and combinations thereof.

In some examples, the film can be transparent or translucent. In some examples, the film can be formed or treated to be resistant to ultraviolet (UV) light. The film can include at least one UV stabilizer selected from the group consisting of hindered amine light stabilizers (HALS), such as 1,6-hexanediamine, N,N′-bis(2,2,6,6-tetrametthyl-4-piperidinyl)-polymer with 2,3,6 trichlor-1,3,5 triazine, n-butyl-1-chimassorb 2020 butamine, and N-butyl-2,2,6,6,-tetramethyl-4-piperidinamine, others known to persons skilled in the art, and combinations thereof.

In some examples, the film can be formed or treated to be antistatic. Adding antistatic compounds to the film can prevent static electricity discharge and adhesion of dust particles but can reduce film transparency. The film can include at least one antistatic compound selected from the group consisting of glycerol monostearate (GMS), amides, higher alcohol sulfuric acid ester salt anionic, quaternary ammonium salt type cationic surfactant, betaine amphoteric surfactant, polyethylene glycol fatty acid ester nonionic, others known to persons skilled in the art, and combinations thereof.

In some examples, thermochromic materials can be incorporated into the film. Thermochromic substances can change their perceived color due to a change in temperature. Such materials can be used to provide a visual indicator of exposure to high heat. The thermochromic materials can be applied uniformly across the film or can be applied as strips or stickers across certain regions.

Two common types of organic thermochromic materials are liquid crystals and leuco dyes. Liquid crystals are easier to engineer for accurate transition temperatures, while the color range is limited by their principle of operation. The temperature response of leuco are more difficult to set with accuracy, yet they offer wider range of colors to be used.

To achieve the thermochromic effect, liquid crystal dyes based on cholesteryl nonanoate or cyanobiphenyls can be used. To incorporate into a plastic phase while preserving thermochromic effect, the liquid crystals can be encapsulated and supplied in the form of suspension. By mixing a few chemically different dyes, it is possible to change the temperature range indicated by the resulting mix. For example, 10% cholesteryl benzoate mixed with 25% cholesteryl nonanoate and 65% of cholesteryl oleyl carbonate will change color at room temperatures between 17 and 23 degrees Celsius, whereas 10% cholesteryl benzoate mixed with 60% cholesteryl nonanoate and 30% cholesteryl oleyl carbonate will change color at higher temperatures between 37 and 40 degrees Celsius.

Liquid crystals can be difficult to add to plastic films due to high temperature and shear during extrusion processes, but they can be applied to the film surface as an ink using specialized printing equipment. High temperatures can disrupt the organized repetitive structure of liquid crystals and the thermochromic effect can disappear. Thus, such dyes can only be used in “reverse” mode, and should they not demonstrate the thermochromic effect anymore at low temperatures, it means the film was exposed to high temperatures.

A leuco dye is a dye which can switch between two chemical forms, one of which is colorless. Reversible thermochromic transformation can be caused by heat and irreversible transformations typically involve reduction or oxidation. Micro-encapsulated thermochromic dyes can be based on mixtures of leuco dyes with other suitable chemicals, displaying a color change between the colorless and the colored form. For example, microcapsules with a combination of crystal violet lactone, weak acid, and a dissociable salt dissolved in dodecanol appear colorless when the solvent is solid. When the solvent melts, the salt dissociates, the pH inside the microcapsule lowers, the dye becomes protonated, its lactone ring opens, and its absorption spectrum shifts drastically, therefore it becomes deeply violet.

The typical leuco dyes are spirolactones, fluorans, spiropyrans, and fulgides. The proton donor acids used with leuco dies include bisphenol A, parabens, 1,2,3-triazole derivates, and 4-hydroxycoumarin. Those acids assist the die to change its color from colorless to colored protonated form. The size of the microcapsules can range between 3 and 5 microns and can be added to plastic films as a filler. Temperatures above about 200 to 230 degrees Celsius can cause irreversible damage to leuco dyes, which can limit the materials of the plastic film to those which can be processed at lower temperatures. A time-limited exposure of some types to about 250 degrees Celsius can be allowed during manufacturing. For example, LDPE can be processed in the temperature window required by leuco dyes.

In some examples, the film can include at least one antiblock agent. In some examples, glass balls can be added as a filler to serve as an antiblock agent for easier opening and installing of film while also dispersing light. By using glass balls, the use of other mineral-based antiblock fillers like calcium carbonate and talc can be avoided, which can allow production of higher clarity and lower haze films. Glass balls can be selected at a diameter of between 1 and 50 microns, or between 2 and 10 microns. In some examples, glass balls of various sizes can be mixed within in the same film. The glass balls content can range from 1 to 10%, and, in some examples, glass balls can be used with a surface treatment for optimized incorporation into a polyethylene plastic matrix, as known to persons skilled in the art.

In some examples, the film can include at least one antifog additive. Such additives can be used to prevent condensation where dripping water could damage goods underneath the membrane. Antifog additives are typically high polarity, hydrophilic substances, which being added to a polyethylene film, for example, can migrate to the film surface, increasing film surface tension and preventing condensation forming droplets but rather forming a continuous moisture layer spread over the film surface. This can prevent water dripping and can further improve light transmission and reduces haze. The film can include at least one antifog additive selected from the group consisting of ethoxylated alkylamines, sorbitan esters, polyglycerol stearates, glycerol sorbitan esters, others known to persons skilled in the art, and combinations thereof.

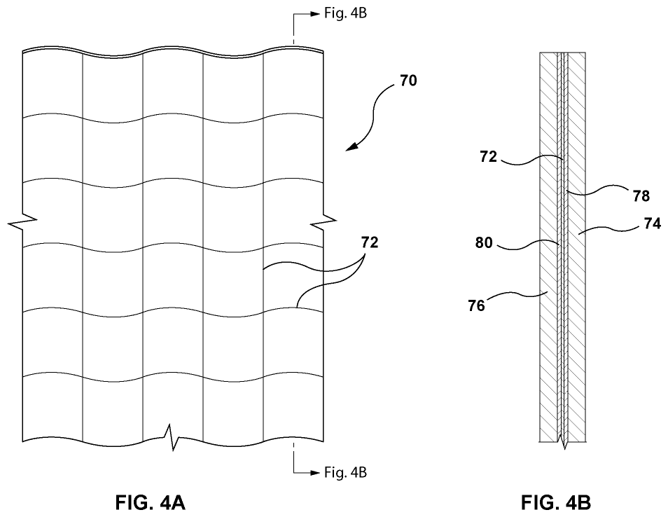

FIGS. 4A and 4B shows a film 70 reinforced with fibers 72. In the example illustrated, the fibers 72 are arranged in a grid, sandwiched between first and second portions of the film 74, 76, and adhesive 78, 80 is arranged respectively between the portions 74, 76 and the fibers 72. The result is a laminated structure that can provide for improved strength and durability. In some examples, the fibers 72 can be formed of the same or similar plastic material as the film portions 74, 76 to exhibit the same melting and shrinkability characteristics in the event of a fire.

For installation, the film used can be based on the needs of the job. In some examples, a roll of film could be 20 feet by 100 feet, another could be 10 feet by 100 feet, and another 16 feet by 100 feet, or any other size that might be narrower/wider or shorter/longer, to meet the needs of that specific facility. The film can be manufactured according to different sizes. This means that installation personnel can bring different sizes to job sites and piece the film together to cover the area that needs to be protected.

Once one end of the film is rolled out, or one end of the film is secured below the ceiling (whether it be to the joists, to the wall under the ceiling by mechanical fastening if necessary, to the ceiling panels in place, or whatever else the building might have), and each piece of film continues to be secured every so many feet with zip ties/cable ties, other fasteners known to persons skilled in the art, and/or methods of securing known to persons skilled in the art, until the end is reached. Any penetrations that are made to allow a method of securing can be covered with vapor barrier adhesive or other tape to attain that feature. This can ensure that small particles do not find their way through the system.

When adjacent pieces of film need to be adjoined together, the two pieces of film are placed such that they overlap, and then they are rolled together, and the roll is secured by a cable tie/zip tie. The penetrations that the cable tie/zip tie make can also be covered with the aforementioned tape.

The ceiling containment barrier can stay in place, typically for a few months, during the construction or re-roofing process. After this is complete, the system can be removed (debris side facing in) such that none of the dirt, dust or debris falls out or contaminates the area of construction or re-roofing project. In some examples, the film can be formed to include a sticky material on one side thereof, which can promote the adherence of debris and allow for greater ease of taking down the system. Once the project is complete, the film and the debris within it can be disposed of. In some examples, the film can be sent for recycling or re-processing.

While the above description provides examples of one or more apparatuses or methods, it will be appreciated that other apparatuses or methods may be within the scope of the accompanying claims.

We claim:

1. A temporary containment barrier, comprising:
a plastic film,
wherein the plastic film is configured to shrink if exposed to heat,
wherein the plastic film is configured to shrink between 20 and 60% in at least one direction if exposed to heat.

2. The temporary containment barrier of claim 1, wherein the plastic film has a melting point between 60 and 140 degrees Celsius.

3. The temporary containment barrier of claim 1, wherein the plastic film has a melting point between 70 and 120 degrees Celsius.

4. The temporary containment barrier of claim 1, wherein the plastic film is configured to shrink between 30 and 50% in at least one direction if exposed to heat.

5. The temporary containment barrier of claim 1, wherein the plastic film is configured to shrink if exposed to a temperature between 50 and 140 degrees Celsius.

6. The temporary containment barrier of claim 1, wherein the plastic film is configured to shrink if exposed to a temperature between 60 and 120 degrees Celsius.

7. The temporary containment barrier of claim 1, wherein the plastic film comprises at least one polymer selected from the group consisting of low-density polyethylene (LDPE), linear low-density polyethylene (LLDPE), high-density polyethylene (HDPE), ethylene-vinyl acetate (EVA), polypropylene (PP), polyamide, polystyrene (PS), polyester, polyvinyl chloride (PVC), ethylene-propylene-diene terpolymer (EPT), copolymers thereof, and combinations thereof.

8. The temporary containment barrier of claim 1, wherein at least a portion of the plastic film is monoaxially oriented.

9. The temporary containment barrier of claim 8, wherein the plastic film has a minimum 3:1 ratio of its orientation in a machine direction compared to a transverse direction.

10. The temporary containment barrier of claim 1, wherein at least a portion of the plastic film is biaxially oriented.

11. The temporary containment barrier of claim 1, wherein the plastic film has a thickness of between 30 and 300 microns.

12. The temporary containment barrier of claim 1, wherein the plastic film has a thickness of between 50 and 200 microns.

13. The temporary containment barrier of claim 1, wherein the plastic film has a thickness of between 75 and 150 microns.

14. The temporary containment barrier of claim 1, wherein the plastic film has a Class A rating when evaluated by ASTM E84 for flame spread, and the plastic film passes when evaluated by NFPA 701 for flame propagation.

15. The temporary containment barrier of claim 14, wherein the plastic film comprises at least one fire retardant additive selected from group consisting of brominated flame retardants, chlorinated flame retardants, phosphorus-based flame retardants, aluminum hydroxide, aluminum trihydrate, magnesium trioxide, magnesium hydroxide, and combinations thereof.

16. The temporary containment barrier of claim 14, wherein the plastic film comprises at least one fire retardant modifier.

17. The temporary containment barrier of claim 16, wherein the at least one fire retardant modifier is selected from the group consisting of decabromodiphenylethane, high-purity antimony trioxide, 1-h-isoindole-1,3(2H)-dione, 2,2′-(1,2-ethanediyl)bis[4,5,6,7-tetrabromo-, phosphoric acid tributyl ester, antimony oxide (Sb₂O₃), benzene, 1,1′-(1-methylethylidene)bis[3,5-dibromo-4,2-phenylene)oxy]]bis-, ethanol, 2,2′-[(1-methylethylidene)bis[(2,6-dibromo-4,1-phenylene)oxy]]bis-, C12-30 α-bromo-chloro, alkenes, c12-24, chloro, phosphoric acid, tris(methylphenyl) ester, and combinations thereof.

18. The temporary containment barrier of claim 1, wherein the plastic film is at least partially biodegradable, and the plastic film comprises at least one pro-biodegradation additive.

19. The temporary containment barrier of claim 18, wherein the at least one pro-biodegradation additive is selected from the group consisting of starches, saccharides, polysaccharides, biodegradable polyesters, polylactic acid, polyhydroxyalkanoates, polycaprolactone, cellulose, and combinations thereof.

20. The temporary containment barrier of claim 1, wherein the plastic film comprises at least one antistatic compound.

21. The temporary containment barrier of claim 20, wherein the at least one antistatic compound is selected from the group consisting of glycerol monostearate (GMS), amides, higher alcohol sulfuric acid ester salt anionic, quaternary ammonium salt type cationic surfactant, betaine amphoteric surfactant, polyethylene glycol fatty acid ester nonionic, and combinations thereof.

22. The temporary containment barrier of claim 1, wherein the plastic film comprises at least one ultraviolet light stabilizer.

23. The temporary containment barrier of claim 1, wherein the plastic film comprises at least one antiblock agent.

24. The temporary containment barrier of claim 1, wherein the plastic film comprises at least one antifog additive.

25. The temporary containment barrier of claim 1, wherein the plastic film comprises at least one fiber arranged as reinforcement.

26. A method of manufacturing the temporary containment barrier of claim 1, comprising extruding the plastic film from a die.

27. A method comprising installing the temporary containment barrier of claim 1 underneath a roof of a building.

28. A temporary containment barrier, comprising:
a plastic film,
wherein the plastic film is configured to shrink if exposed to heat,
wherein the plastic film comprises at least one fire retardant modifier,
wherein the plastic film comprises at least one antistatic compound,
wherein the plastic film comprises at least one antiblock agent, and
wherein the plastic film comprises at least one antifog additive.

29. A temporary containment barrier, comprising:
a plastic film,
wherein the plastic film has a melting point between 60 and 140 degrees Celsius,
wherein the plastic film is oriented to shrink between 20 and 60% in at least one direction if exposed to a temperature between 50 and 140 degrees Celsius,
wherein the plastic film has a thickness of between 30 and 300 microns,
wherein the plastic film comprises at least one fire retardant modifier,
wherein the plastic film has a Class A rating when evaluated by ASTM E84 for flame spread, and
wherein the plastic film passes when evaluated by NFPA 701 for flame propagation.

30. A plastic film for use as a temporary containment barrier,
wherein the plastic film comprises at least one polymer selected from the group consisting of low-density polyethylene (LDPE), linear low-density polyethylene (LLDPE), and high-density polyethylene (HDPE),
wherein the plastic film is oriented to shrink between 20 and 60% in at least one direction if exposed to a temperature between 50 and 140 degrees Celsius,
wherein the plastic film comprises at least one fire retardant modifier,
wherein the plastic film has a Class A rating when evaluated by ASTM E84 for flame spread,
wherein the plastic film passes when evaluated by NFPA 701 for flame propagation,
wherein the plastic film comprises at least one pro-biodegradation additive, and
wherein the plastic film comprises at least one antistatic compound.
